(19) United States
(12) Patent Application Publication
(10) Pub. No.: US 2019/0211815 A1
(43) Pub. Date: Jul. 11, 2019

(54) BYPASS SYSTEM FOR REGULATING LUBRICATION OF RECIPROCATING MACHINES

(71) Applicant: GE Oil & Gas Compression Systems, LLC, Houston, TX (US)

(72) Inventors: Ashraf O. Elmessidi, Oklahoma City, OK (US); Moien Farmahini, Oklahoma City, OK (US); Thomas Hurley, Oklahoma City, OK (US); Pejman Kazempoor, Oklahoma City, OK (US); Nasr Alkadi, Oklahoma City, OK (US)

(21) Appl. No.: 15/864,653

(22) Filed: Jan. 8, 2018

(51) Int. Cl. F04B 39/02; F04B 35/00

(52) U.S. Cl. CPC F04B 39/0207; F02B 75/02; F04B 39/0223; F04B 35/002

(57) ABSTRACT

A lubrication bypass system is disclosed for controlling flow of a lubricant to a reciprocating machine, such as two-stroke engines and two-stroke compressors, based upon one or more operating parameters. The lubrication bypass system can be positioned in fluid communication with a lubrication system that transports a primary flow of the lubricant from a lubricant reservoir to the reciprocating machine cylinder at a predetermined primary flow rate. The lubrication bypass system can be configured to divert a portion of the primary flow, a bypass flow, from the lubrication system at a bypass flow rate based upon the operating parameters. As a result, a secondary flow of lubricant remaining within the lubrication system can be supplied to the reciprocating machine at a secondary flow rate that is less than the primary flow rate. In this manner, the lubrication bypass system can regulate the secondary flow rate.

### BACKGROUND

Internal combustion engines are a type of reciprocating machine that combust a fuel to convert chemical energy stored within the fuel into mechanical energy. As an example, internal combustion engines generally include a cylinder containing a reciprocating piston and produce mechanical energy from combustion the fuel in an operating cycle. Two-stroke engines, also referred to as “two-cycle” engines, are internal combustion engines that perform the operating cycle in two piston strokes, an up stroke and a down stroke. While two-stroke engines provide a high power-to-weight ratio compared to other types of internal combustion engines, such as four-stroke engines, two-stroke engines face challenges meeting regulatory requirements related to volatile organic compound (VOC) emissions.

Two stroke engines use a fluid lubricant to reduce friction between components that move against one another, such as an engine piston and an engine cylinder. A manufacturer or other authority generally provides operators recommended lubrication rates that depend upon various operating parameters of the engine, such as engine speed and engine load. In certain aspects, the engine speed can be the rotation speed of the crankshaft, and the engine load can be a measure of external mechanical resistance against which the engine acts.

In general, the recommended lubrication rate rises as engine load and/or engine speed increase. However, existing two-stroke engines often lack controls for matching the lubrication rate with the recommended lubrication rate. Instead, the fluid lubricant is usually supplied to the engine at a constant rate, regardless of the engine operating conditions. Under some operating conditions, such as low engine load, the actual lubrication rate is significantly greater than the recommended lubrication rate, resulting in excess fluid being supplied to the engine. This excess of fluid lubricant within the engine is undesirable, as the excess lubricant can combust, thereby increasing the amount of VOCs emitted by the engine.

### SUMMARY

To address this difficulty, a new lubrication bypass system described herein has been invented. As discussed in detail below, the new lubrication bypass system is configured to work in conjunction with a lubrication system to regulate a flow of lubricant supplied by the lubrication system to two-stroke reciprocating machines, such as compressors and engines. In an embodiment, the lubrication system includes a lubrication line and a pump in fluid communication with a reciprocating machine (e.g., a reciprocating machine cylinder). A primary flow of a fluid lubricant is drawn from a reservoir into the lubrication line by the pump. In certain embodiments, a rate of the primary flow can be controlled by the speed of the reciprocating machine or it can be set manually by an operator.

The new lubrication bypass system can include a bypass line, a bypass valve, and a bypass valve controller. The bypass line is in fluid communication with the lubrication line at a junction and receives a bypass flow of the fluid lubricant diverted from the lubrication line at a bypass flow rate. The bypass valve is positioned along the bypass line and is configured to move between open and closed positions under control of a bypass valve controller for adjustment of the bypass flow rate.

A second portion of the primary flow, referred to as a secondary flow, remains within the lubrication line and travels through the junction to the reciprocating machine at a secondary flow rate. Because the primary flow is split between the bypass flow and the secondary flow at the junction, the lubrication bypass system regulates the secondary flow rate by adjusting the bypass flow rate. Optionally, the lubrication bypass system can also include a limiting valve positioned between the bypass valve and the lubrication line that is configured to limit the bypass flow rate, thereby ensuring that a minimum secondary flow rate is maintained and damage to the reciprocating machine due to insufficient lubrication is avoided.

The lubrication bypass system is also configured to regulate the secondary flow rate based upon one or more operating parameters of the reciprocating machine. In one embodiment, the lubrication bypass system can be configured for open-loop control of the secondary flow rate based at least upon a current load and a current speed of the reciprocating machine. As an example, measurements of the current load and the current speed of the reciprocating machine are transmitted to the bypass valve controller in real-time and the bypass valve controller uses these measurements to determine a target secondary flow rate suitable for the current load (e.g., a manufacturer's recommendation). Subsequently, the bypass valve controller commands the bypass valve to adopt a position that is calibrated to achieve the target secondary flow rate.

In another embodiment, the lubrication bypass system can be configured for closed-loop control of the secondary flow rate based upon one or more operating parameters of the reciprocating machine. As discussed above, the bypass valve controller is configured to determine the target secondary flow rate based upon operating parameters of the reciprocating machine, such as the current load and current speed, and commands the bypass valve to adopt a position that is calibrated to achieve the target secondary flow rate. In contrast to the open loop control described above, the bypass valve controller additionally receives measurements of the current secondary flow rate resulting from adjustment of the bypass flow rate. Subsequently, the bypass valve controller determines a deviation between the current secondary flow rate and the target secondary flow rate. When this deviation exceeds a threshold, the bypass valve controller further commands the bypass valve to adjust the bypass flow in order to reduce the deviation.

### DESCRIPTION OF DRAWINGS

These and other features will be more readily understood from the following detailed description taken in conjunction with the accompanying drawings, in which:

FIG. 1 is a diagram illustrating one exemplary embodiment of an operating environment containing a reciprocating machine in fluid communication with a lubrication system and a lubrication bypass system in fluid communication with the lubrication system;

FIG. 2 is a side view of one exemplary embodiment of the reciprocating machine of FIG. 1;

FIG. 3 is a diagram illustrating one exemplary embodiment of the lubrication bypass system of FIG. 1;

FIG. 4 is a diagram illustrating another exemplary embodiment of the lubrication bypass system of FIG. 1;

FIG. 5 is a flow diagram illustrating one exemplary embodiment of a method for lubricating a reciprocating machine; and

FIG. 6 is a flow diagram illustrating another exemplary embodiment of a method for lubricating a reciprocating machine.

It is noted that the drawings are not necessarily to scale. The drawings are intended to depict only typical aspects of the subject matter disclosed herein, and therefore should not be considered as limiting the scope of the disclosure. Those skilled in the art will understand that the systems, devices, and methods specifically described herein and illustrated in the accompanying drawings are non-limiting exemplary embodiments and that the scope of the present invention is defined solely by the claims.

### DETAILED DESCRIPTION

Compressors are a type of reciprocating machine that produce compressed gas. A compressor generally includes a compressor cylinder containing a compressor piston. The compressor piston is coupled to a crankshaft to drive the compressor piston to reciprocate within the compressor cylinder. The reciprocating movement of the compressor piston reduces the volume of the gas within the compressor cylinder ahead of the compressor piston and produces the compressed gas.

The crankshaft can be driven by an engine, such as an internal combustion engine. Internal combustion engines are another type of reciprocating machine that combust a fuel within an engine cylinder containing an engine piston. Hot and high-pressure combustion gases resulting from combustion drive the piston to reciprocate within the engine cylinder. By coupling the engine piston to the crankshaft, the reciprocating, linear motion of the piston is converted into rotational motion of the crankshaft.

In operation, a fluid lubricant is supplied to at least one of the engine and the compressor. As an example, the fluid lubricant is drawn from a reservoir, pressurized, and sprayed on the cylinder walls of the engine and/or the compressor, amongst other surfaces (e.g., the crankshaft, rods connecting the crankshaft to the piston, etc.). In one aspect, the fluid lubricant forms a film having a thickness sufficient to separate adjacent components, reducing friction and wear. In another aspect, the fluid lubricant removes heat from the reciprocating machine, inhibiting thermal breakdown of the fluid lubricant. In a further aspect, the fluid lubricant removes internally generated debris (e.g., debris resulting from abrasive wear), mitigating wear that can occur due to the presence of the debris.

Manufacturers or other authorities typically recommend flow rates for supply of the fluid lubricant to a reciprocating machine under different operating parameters, such as speed and load. This recommended flow rate is often used by operators to maintain an approximately constant volume of lubricant within the reciprocating machine that is suitable for the specified operating parameters. However, some reciprocating machines, such as two-stroke engines and two-stroke compressors, lack mechanisms for adjusting the lubricant flow rate to match the recommended flow rate when these operating parameters change. Instead, the fluid lubricant is supplied at a constant rate, insensitive to changing operating parameters. However, when operating a reciprocating machine at low loads, this constant rate of lubrication often exceeds the recommended lubrication rate and excess lubricant can accumulate.

Accordingly, a new lubrication bypass system is disclosed for controlling flow of lubricant to a reciprocating machine, such as two-stroke engines and two-stroke compressors, based upon one or more operating parameters. As an example, the lubrication bypass system is positioned in fluid communication with a lubrication system that transports a fluid lubricant from a lubricant reservoir to the reciprocating machine (e.g., a reciprocating machine cylinder) at a primary flow rate. The lubrication bypass system is configured to divert a portion of the primary flow, referred to as a bypass flow, from the lubrication system at a bypass flow rate. A portion of the primary flow remaining within the lubrication line, referred to as a secondary flow, is delivered to the reciprocating machine at a secondary flow rate that is less than the primary flow rate. The bypass flow rate is adjusted, based upon one or more current operating parameters of the reciprocating machine, to achieve a secondary flow rate that is approximately equal to a recommended lubrication rate for the reciprocating machine operating at the current operating parameters. In this manner, over-lubrication of the reciprocating machine can be avoided.

Exemplary technical effects of the methods, systems, and devices described herein can include, by way of example, regulating a rate at which a fluid lubricant is supplied to reciprocating machines, such as two-stroke engines and two-stroke compressors. In one aspect, reducing excess lubricant supplied to two-stroke engines and two-stroke compressors results in less lubricant consumption and lower operating cost. In another aspect, reducing excess lubricant supplied to two-stroke engines and two-stroke compressors typically increases their operating life, as damage resulting from over-lubrication (e.g., to bearings, seals, etc.) can be avoided. In a further aspect, reducing the volume of excess lubricant supplied to two-stroke engines and two-stroke compressors generally results in less lubricant combustion and reduced VOC emissions. Reducing the volume of VOCs exhausted from a reciprocating machine cylinder can also reduce extend the service life of a catalyst located in an exhaust system of the reciprocating machine because a rate of catalyst deactivation that occurs due to catalytic oxidation of VOCs by the catalyst is reduced.

Embodiments of the lubrication bypass system are discussed below in the context of lubrication of cylinders of reciprocating machines, such as two-stroke engines and two-stroke compressors. However, the disclosed embodiments can be employed for control of lubrication to any portion of any reciprocating machine without limit.

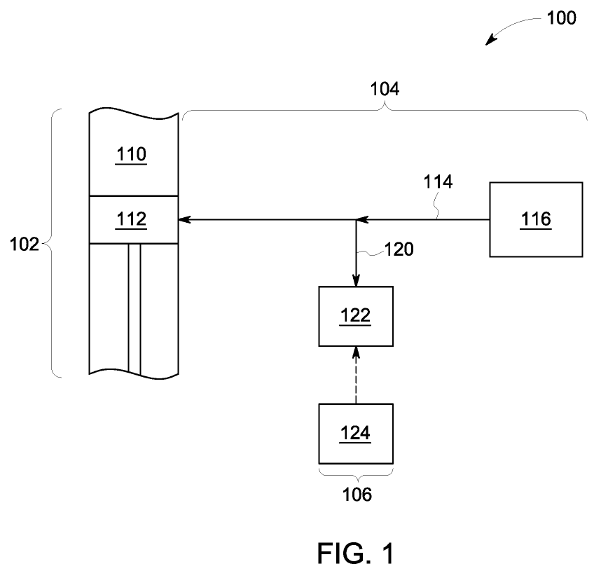

FIG. 1 illustrates one exemplary embodiment of an operating environment 100 containing a reciprocating machine 102, a lubrication system 104, and a lubrication bypass system 106. The reciprocating machine 102 includes a cylinder 110 and a reciprocating piston 112. The cylinder 110 can be a combustion cylinder of a two-stroke engine or a compressor cylinder of a two-stroke compressor. The lubrication system 104 includes a lubrication line 114 in fluid communication with a reservoir 116 and the cylinder 110 and it is configured to deliver a flow of fluid lubricant to the cylinder 110 at a substantially constant primary flow rate using a pump (not shown).

As discussed in greater detail below, a recommended lubrication rate for the reciprocating machine 102 can vary during operation while the primary flow rate remains constant and lead to over-lubrication of the reciprocating machine 102. Accordingly, the lubrication bypass system 106 are configured to inhibit over-lubrication of the reciprocating machine 102 by diverting a portion of the primary flow in response to changing operating parameters. In one exemplary embodiment, the lubrication bypass system 106 includes a bypass line 120 in fluid communication with the lubrication line 114 and a bypass valve 122 positioned along the bypass line 120 and in communication with a bypass valve controller 124. The bypass valve 122 is configured to move between an open position and a closed position in response to commands from the bypass valve controller 124. In this manner, a first portion of the primary flow, referred to as a bypass flow, is diverted from the lubrication line 114 to the bypass line 120 at a bypass flow rate. The bypass flow rate is adjustable by the bypass valve 122 under the control of the bypass valve controller 124. In certain embodiments, the bypass valve controller 124 controls the bypass valve 122 based upon one or more of the operating parameters of the reciprocating machine 102, such as load. As a result, a second portion of the primary flow remaining within the lubrication line 114, referred to as a secondary flow, is delivered to the cylinder 110 at a non-zero secondary flow rate that is less than the primary flow rate. Thus, the secondary flow rate can be varied with changes in operating parameters of the reciprocating machine 102, mitigating over-lubrication of the reciprocating machine 102.

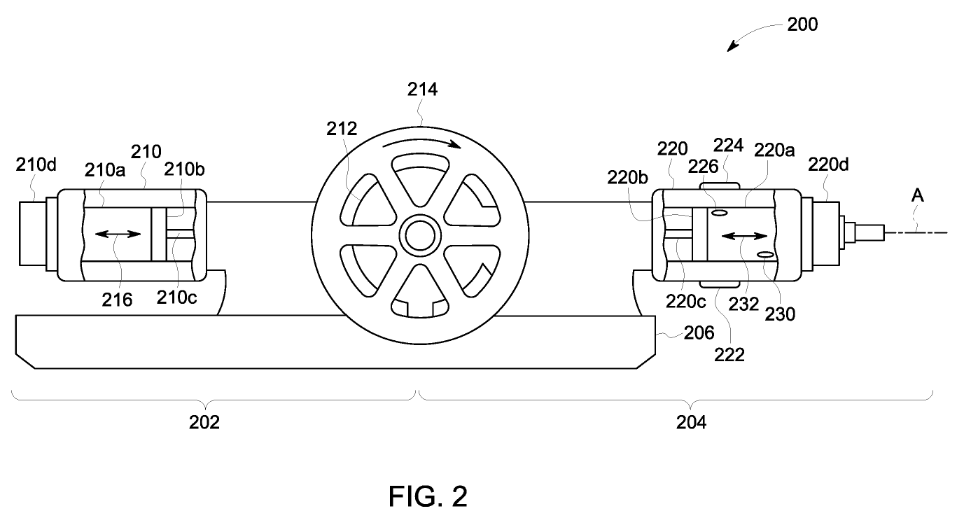

The reciprocating machine 102 can take the form of a compression system 200. As shown in FIG. 2, the compression system 200 includes a power portion 202, a compression portion 204, and a skid 206. Embodiments of the compression system 200 can include, but are not limited to, Ajax® DP-60, Ajax® DP-81, Ajax® DPC-2200 series, Ajax® DPC-2800 series, Ajax® DPC-2800 LE, ULE, and XLE, and Cooper-Bessemer GMV and GMW series (Baker Hughes, a General Electric Company, Boston, Mass., USA).

The power portion 202 includes an engine 210, a crankcase 212, and a flywheel 214. As shown, the engine 210 is a horizontally mounted, two-stroke internal combustion engine. The engine 210 includes an engine cylinder 210a, a reciprocating engine piston 210b, an engine piston rod 210c, and an engine cylinder head 210d. The engine piston rod 210c is coupled to the engine piston 210b at one end and to a crankshaft (not shown) positioned within the crankcase 212 at the other end. In certain embodiments, the engine cylinder 210a and the engine piston 210b can each have a substantially complementary, right circular cylindrical shape that is generally concentric about a central axis A. The flywheel 214 is coupled to the crankshaft and the inertial mass of the flywheel 214 functions as a reservoir for angular momentum. The engine piston 210b is configured to reciprocate within the engine cylinder 210a (arrow 216).

The compression portion 204 includes a compressor 220. As shown, the compressor 220 is a horizontally mounted, two-stroke compressor. The compressor 220 includes a compressor cylinder 220a, a compressor piston 220b, a compressor piston rod 220c, a compressor cylinder head 220d, and valves 222 and 224. The compressor piston rod 220c is coupled to the compressor piston 220b at one end and to the crankshaft at the other end. In certain embodiments, the compressor cylinder 220a and the compressor piston 220b can each have a substantially complementary, right circular cylindrical shape that is generally concentric about the central axis A. The compressor cylinder 220a also includes an inlet passage 226 and an outlet passage 230 that are in fluid communication with the valves 222, 224.

The valves 222, 224 can include a variety of types of valve members. Examples include, but are not limited to, poppet valves that are biased against openings connected to the passages 226, 230. In some embodiments, the valves 222, 224 are check valves configured to open in response to a pressure in the compressor cylinder 220a that is greater than a threshold pressure or less than a threshold pressure.

In operation, the engine 210 drives the flywheel 214 and the compressor piston 220b via the engine piston rod 210c. Two-stroke engines, such as engine 210, are configured to perform an operating cycle in two strokes of the engine piston 210b, one up stroke and one down stroke. During an intake portion of the operating cycle, the fuel-air mixture is received within the engine cylinder 210a, ahead of the engine piston 210b. During a compression portion of the operating cycle, following the intake portion of the operating cycle, the engine piston 210b moves towards the engine cylinder head 210d (the up stroke) and the engine piston 210b compresses the fuel-air mixture to complete the compression portion of the operating cycle. As the engine piston 210b nears top dead center, its farthest position from the crankshaft, the compressed fuel-air mixture is ignited. Combustion of the fuel-air mixture generates hot, high-pressure gases that drive the engine piston 210b away from the engine cylinder head 210d (the down stroke), and rotate the crankshaft to perform a power portion of the operating cycle. During the down stroke, the engine piston 210b reveals an exhaust port in the cylinder wall (not shown) and the combusted fuel-air mixture exits the engine cylinder 210a through the exhaust port to complete an exhaust portion of the operating cycle. When the engine piston 210b is near bottom dead center, its closest position to the crankshaft, the engine piston 210b unblocks an intake port (not shown) and allows a fresh charge of fuel-air mixture to enter the engine cylinder 210a ahead of the engine piston 210b.

The flywheel 214 rotates with the crankshaft in the crankcase 212 and the movement of the crankshaft causes the compressor piston 220b to reciprocate within the compressor cylinder 220a (arrow 232). As the compressor piston 220b moves toward the crankcase 212, the valve 224 opens in response to the drop in pressure in the compressor cylinder 220a, and a compressible fluid (e.g., air, natural gas, etc.) is drawn into the compressor cylinder 220a through the inlet passage 226. Concurrently, the valve 222 is closed, inhibiting fluid from moving through the outlet passage 230. Subsequently, as the compressor piston 220b translates towards the compressor head 220d, the valve 224 closes in response to the increase in pressure, and the compressor piston 220b decreases the volume of the compressor cylinder 220a in which the fluid is disposed, thereby elevating the fluid's pressure. As the compressor piston 220b nears the end of its travel towards the compressor head 220d, the valve 222 opens in response to the increase in pressure. The fluid, now pressurized, exits the compressor cylinder 220a through the outlet passage 230.

The compressor 220 is illustrated and discussed above as a single-acting compressor, where compression of the fluid occurs in one direction of the compressor piston 220b. However, alternative embodiments of the compressor can include additional valves and passages for operation as a double-acting compressor, where compression of the fluid occurs in both directions of the compressor piston.

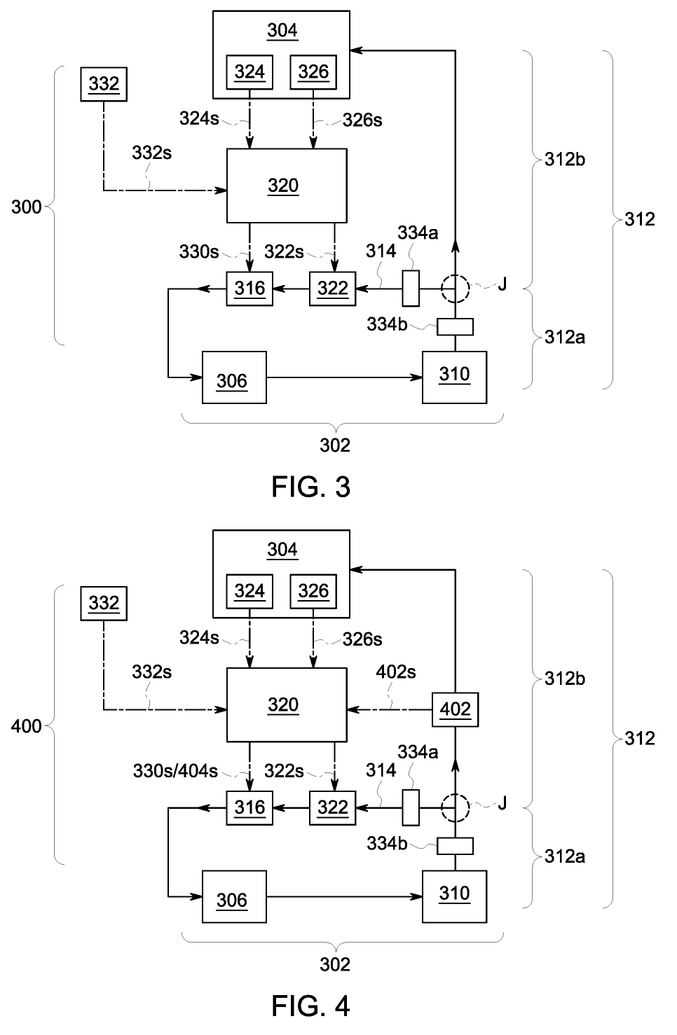

FIG. 3 illustrates an exemplary embodiment of the lubrication bypass system 106 in the form of lubrication bypass system 300. As shown, the lubrication bypass system 300 is in fluid communication with a lubrication system 302 configured to deliver a fluid lubricant to a reciprocating machine 304. In certain embodiments, the reciprocating machine 304 can be compression system 200 and a flow of fluid lubricant is supplied to at least one of the engine 210 (e.g., engine cylinder 210a) and the compressor 220 (e.g., compressor cylinder 220a). In other embodiments, not shown, the reciprocating machine can be a stand-alone two-stroke engine or a two-stroke compressor different than that of engine 210 or compressor 220.

The lubrication system 302 includes a reservoir 306, a pump 310, and a lubrication line 312 in fluid communication with the reciprocating machine 304. The lubrication line 312 extends from the reservoir 306 to the reciprocating machine 304. As shown, the lubrication line 312 includes a first portion 312a coupled to a second portion 312b at a junction J. The first portion 312a of the lubrication line 312 extends between the reservoir 306 and the junction J and the second portion 312b of the lubrication line 312 extends between the junction J and the reciprocating machine 304. The pump 310 is positioned along the first portion 312a of the lubrication line 312 and configured to draw the fluid lubricant from the reservoir 306 at a primary flow rate. In alternative embodiments, not shown, the lubrication line can extend from the pump to the reciprocating machine.

A recommended lubrication rate for a reciprocating machine can be a function both its speed and load. In certain embodiments, the pump 310 can be driven by the reciprocating machine 304 (e.g., engine gear driven). As a result, when the speed of the reciprocating machine 304 changes, the primary flow rate is automatically adjusted in response. Similarly, when the speed of the reciprocating machine 304 remains constant, the primary flow rate is approximately constant.

Conversely, the pump 310 is typically manually adjusted by an operator to match the primary flow rate with the recommended lubrication rate at maximum load (e.g., 100% load) for the engine speed. As an example, when the lubrication system 302 lubricates the engine 210, the primary flow rate can be the recommended lubrication rate for the current engine speed and the maximum load of the engine cylinder 210a. In another example, when the lubrication system 302 lubricates the compressor 220, the primary flow rate can be the recommended lubrication rate for the current compressor speed and the maximum load of the compressor cylinder 220a. As the compressor 220 of reciprocating machine 304 is driven by the engine 210, the compressor speed can be the engine speed.

However, reciprocating machines are not always operated at maximum load. Rather, reciprocating machines can be operated within a range of loads (e.g., 60% to 100%). Furthermore, the recommended lubrication rate for reciprocating machines typically decreases with load, at a constant speed. Because existing lubrication systems do not include mechanisms for automatically reducing the primary flow rate in response to decreasing load, the primary flow rate is generally maintained at the recommended lubrication rate for maximum load, regardless of the actual load, in order to prevent damage to the reciprocating machine. As a result, the primary flow rate generally exceeds the recommended lubrication rate when the reciprocating machine is operated at less than maximum load.

In order to avoid over-lubrication of the reciprocating machine 304, the lubrication bypass system 300 is also configured to adjust the bypass flow rate based upon the load of the reciprocating machine 304. In this manner, the flow of lubricant delivered to the reciprocating machine 304 is reduced from the primary flow rate, by the amount of the bypass flow rate, to the secondary flow rate. As discussed in detail below, the bypass flow rate is dynamically adjusted in response to changes in both the current speed and current load of the reciprocating machine 304 to achieve a target secondary flow rate that is approximately equal to the recommended lubrication rate for the current speed and the current load.

As shown, the lubrication bypass system 300 includes a bypass line 314, a bypass valve 316, and a bypass valve controller 320. A first end of the bypass line 314 is in fluid communication with the lubrication line 312 at the junction J and the bypass valve 316 is positioned along the bypass line 314. A second end of the bypass line 314, opposite the first end, terminates at a predetermined location. As shown, the second end of the bypass line 314 terminates at the reservoir 306, allowing the bypass flow to return to the lubrication system 302. However, in other embodiments, not shown, the second end of the lubrication line can terminate at a tank or other vessel that is configured to store the fluid lubricant and is separate from the lubrication system.

The bypass valve 316 is configured to move between an open position and a closed position. As discussed in detail below, the bypass valve controller is configured to control the position of the bypass valve 316 between open and closed positions. When the bypass valve 316 is at least partially open, a portion of the primary flow, referred to as a bypass flow, is diverted from the first portion 312a of the lubrication line 312 to the bypass line 314 at a bypass flow rate. The portion of the fluid lubricant remaining in the lubrication line 312, referred to as a secondary flow, travels through the junction J and the second portion 312b of the lubrication line 312 to the reciprocating machine 304 at a secondary flow rate.

The magnitude of the bypass flow rate and the secondary flow rate depend upon the degree to which the bypass valve 316 is open. As an example, when the bypass valve 316 is completely closed, the bypass flow rate is approximately zero and the secondary flow rate is approximately equal to the primary flow rate. In contrast, when the bypass valve 316 is completely open, the bypass flow rate adopts a maximum bypass flow rate and the secondary flow rate decreases from the primary flow rate to a minimum secondary flow rate.

In certain embodiments, it can be beneficial to limit the maximum bypass flow rate. As an example, if the maximum bypass flow rate is too great, the minimum secondary flow rate can fall below a recommended minimum lubrication rate (e.g., a manufacturer recommendation) for the current speed and load of the reciprocating machine 304. Should the minimum secondary flow rate remain below the recommended minimum for an extended period of time, benefits achieved by the fluid lubricant (e.g., reduced friction and wear, heat dissipation, removal of debris, etc.) can be substantially reduced or eliminated.

Accordingly, the lubrication bypass system 300 can optionally include a limiting valve 322. As shown in FIG. 3, the limiting valve 322 is positioned within the bypass line 314, between the junction J and the bypass valve 316. The limiting valve 322 is configured to limit the bypass flow rate to a predetermined maximum value that maintains the secondary flow rate at or above its minimum value. Thus, even when the bypass valve 316 is placed in its completely open position, the secondary flow rate remains above the recommended minimum lubrication rate.

The bypass valve 316 is configured to adjust the bypass flow rate under control of the bypass valve controller 320. In an embodiment, the bypass valve controller 320 receives measurements of the current speed and current load of the reciprocating machine 304 and determines a target secondary flow rate (e.g., a recommended lubrication rate) for the current speed and current load. As shown, the bypass valve controller 320 receives a load signal 324s that contains data representing the current load of the reciprocating machine 304 and a speed signal 326s that contains data representing the current speed of the reciprocating machine 304.

The load signal 324s is output by a load sensor 324 in communication with the reciprocating machine 304. In certain embodiments, the load sensor 324 can be configured to measure the current load in terms of a mean effective pressure. Mean effective pressure quantifies the ability of the reciprocating machine 304 to perform work independent of its displacement. As an example, when reciprocating machine 304 is engine 210, the mean effective pressure quantifies the current load of the engine 210. In another example, when reciprocating machine is compressor 220, the mean effective pressure quantifies the current load of the compressor 220.

In certain embodiments, the mean effective pressure is a brake mean effective pressure (BMEP). However, in alternative embodiments, the mean effective pressure can be one of a gross indicated mean effective pressure (IMEP_{g}), a net indicated mean effective pressure (IIMEPₙ), a pumping mean effective pressure (PMEP), or a friction mean effective pressure (FMEP).

In further embodiments, the load sensor can quantify the current load by a measure different from mean effective pressure. In one aspect, the load sensor can be a temperature sensor configured to estimate the current load based upon measurements of exhaust temperature of the reciprocating machine. In another aspect, the load sensor can be an oxygen sensor configured to estimate the current load based upon measurements of oxygen content of the reciprocating machine. In a further aspect, the load sensor can be a pressure sensor configured to estimate the current load based upon measurements of a pressure of fuel supplied to the reciprocating machine.

The speed signal 326s is output by a speed sensor 326 in communication with the reciprocating machine 304. In certain embodiments, the speed sensor 326 is configured to measure the engine speed based upon speed (e.g., revolutions per minute) of the crankshaft.

After receiving the load signal 324s and the speed signal 326s, the bypass valve controller 320 is configured to determine a target bypass flow rate that achieves the target secondary flow rate for the current speed and the current load of the reciprocating machine 304. As an example, the bypass valve controller 320 can use a predetermined formula or a lookup table along with the current speed and the current load of the reciprocating machine 304 to determine the target secondary flow rate. The bypass valve controller 320 similarly determines the primary flow rate using the current speed and the maximum load of the reciprocating machine 304. The target bypass flow rate is determined to be the difference between the primary flow rate and the target secondary flow rate.

In certain embodiments, the bypass valve controller 320 obtains either of the predetermined formula and the lookup table from a storage device (e.g., one or more local or remote storage devices in communication with the bypass valve controller 320). An exemplary embodiment of a lookup table containing recommended primary flow rates, target secondary flow rates, and target bypass flow rates, is illustrated below in Table 1. The flow rates are presented in pints per day (p/d) for the engine 210 at a constant speed of 440 rpm and the engine load is represented in BMEP.

TABLE 1
Recommended Lubrication Rate

| | | | Target | Target |
|---|---|---|---|---|
| | | Recommended | Secondary | Bypass |
| Speed | Load | Primary Flow | Flow Rate | Flow Rate |
| (rpm) | (BMEP) | Rate (p/d) | (p/d) | (p/d) |
| 440 | 40 | 12.8 | 5.1 | 7.7 |
| 440 | 50 | 12.8 | 6.4 | 6.4 |
| 440 | 60 | 12.8 | 7.7 | 5.1 |
| 440 | 70 | 12.8 | 9.0 | 3.8 |
| 440 | 80 | 12.8 | 10.2 | 2.6 |
| 440 | 90 | 12.8 | 11.5 | 1.3 |
| 440 | 100 | 12.8 | 12.8 | 0 |

After determining the target bypass flow rate, the bypass valve controller 320 further generates and transmits a valve control signal 330s to the bypass valve 316. The valve control signal 330s commands the bypass valve 316 to move to a position that effects the target bypass flow rate and thereby achieves the target secondary flow rate. In certain embodiments, the bypass valve controller 320 can be part of a stepper motor having a rotatable shaft (not shown) configured to engage the bypass valve 316. The valve control signal 330s causes the shaft of the stepper motor to rotate by a calibrated amount, thereby causing the bypass valve 316 to move to the position that achieves the target bypass flow rate.

Optionally, the lubrication bypass system 300 can be further configured to regulate the target bypass flow rate based upon temperature, in addition to current speed and current load of the reciprocating machine 130. The viscosity of the fluid lubricant changes with temperature, decreasing with increasing temperature and increasing with decreasing temperature. Because the viscosity of the fluid lubricant is related to its ability to reduce friction, it can be beneficial to account for effects of temperature on the fluid lubricant when determining the target secondary flow rate.

As an example, a temperature sensor 332 can be positioned in contact with a portion of the reciprocating machine 304, or adjacent to the reciprocating machine 304, and configured to output a temperature signal 332s to the bypass valve controller 320. The temperature signal 332s includes data representing a temperature of the fluid lubricant or any other temperature that influencing the temperature of the fluid lubricant, such as an ambient temperature surrounding the reciprocating machine 304. One or more of the primary flow rate, the predetermined formula, and the lookup table can also be updated to incorporate this constant primary flow rate and used to determine a temperature-compensated target bypass flow rate. This temperature-compensated target bypass flow rate is employed by the lubrication bypass system 300 to regulate the target secondary flow rate as discussed above.

Determining the target bypass flow rate using the current speed and the current load of the reciprocating machine 304, as discussed above, can be beneficial when normal operation (e.g., outside of startup or shutdown) of the reciprocating machine 304 is conducted at a variable speed. However, when normal operation of the reciprocating machine 304 is conducted at a single speed, the primary flow rate can be approximately constant and determination of the target bypass flow rate can be simplified. As an example, the predetermined formula or the lookup table is updated to incorporate this constant primary flow rate. Under this circumstance, the bypass valve controller 320 determines the target bypass flow rate directly from the predetermined formula or the lookup table using the current load, without the current speed.

In certain embodiments, the limiting valve 322 is configured to adjust the maximum bypass flow rate under control of the bypass valve controller 320. As an example, the bypass valve controller 320 can receive the maximum bypass flow rate (e.g., from a user input or a data storage device) and transmit a limiting valve signal 322s to the limiting valve 322. The limiting valve signal 322s is operative to command the limiting valve 322 to adopt a position that achieves the maximum bypass flow rate. In alternative embodiments, the limiting valve can be manually adjusted by an operator to set the maximum bypass flow rate.

It will be appreciated that the bypass flow rates controlled by the bypass valve 316 and the maximum bypass flow rate controlled by the limiting valve 322 are relatively small. As an example, a bypass flow rate of 5.1 pints/day is approximately 0.0004 gallons per minute. By comparison, the water flow from a kitchen faucet can be approximately 1.8 gallons per minute. Due to these low bypass flow rates, the bypass valve 316 and the limiting valve 322 have small flow areas and these flow areas can be easily obstructed if solid contaminants are present in the fluid lubricant. To inhibit obstruction of the bypass valve 316 and the limiting valve 322, embodiments of the lubrication bypass system 300 optionally include one or more filters configured to substantially remove solids from the fluid lubricant. In one example, a filter 334a is positioned within the bypass line 314 and interposed between the bypass valve 316 and the junction J. In another example, when the limiting valve 322 is present, the filter 334a is positioned within the bypass line 314 between the limiting valve 322 and the junction J. In a further example, a filter 334b can be positioned within the lubrication line 312, prior to the junction J (e.g., interposed between the pump 310 and the junction J).

FIG. 4 illustrates another exemplary embodiment of the lubrication bypass system 106 in the form of lubrication bypass system 400. The lubrication bypass system 400 can be similar to the lubrication bypass system 300, differing by the addition of a flow rate sensor 402. As discussed in detail below, the flow rate sensor 402 allows the lubrication bypass system 400 to perform closed-loop control of the secondary flow rate.

The flow rate sensor 402 is configured to measure a current secondary flow rate. As shown, the flow rate sensor 402 is positioned in the second portion 312b of the lubrication line 312 and the flow rate sensor 402 outputs a flow rate signal 402s to the bypass valve controller 320 that contains data representing the current secondary flow rate. After the bypass valve controller 320 transmits the valve control signal 330s and receives the flow rate signal 402s, it compares the current secondary flow rate to the target secondary flow rate.

When the current secondary flow rate deviates from the target secondary flow rate by greater than a predetermined threshold, the current secondary flow rate is sufficiently different from the target secondary flow rate that an adjustment of the bypass flow rate is desirable to ensure that excess lubrication supplied to the reciprocating machine 304 is minimized. Accordingly, the bypass valve controller 320 changes the valve control signal transmitted to the bypass valve 316 from the valve control signal 330s to a valve control signal 404s to effect this adjustment and thereby reduce the deviation to less than the threshold.

Alternatively, when the deviation is less than the predetermined threshold, the current secondary flow rate is sufficiently close to the target secondary flow rate that no adjustment of the bypass flow rate is necessary. Accordingly, under this condition, the valve control signal 404s can be approximately the same as valve control signal 330s. Alternatively, if the bypass valve is configured to maintain its position absent further command, the bypass valve controller can refrain from output of the second valve control signal.

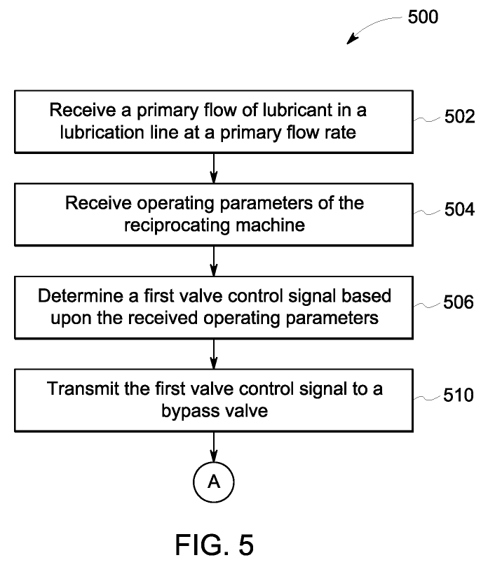

FIG. 5 is a flow diagram illustrating an exemplary embodiment of a method 500 for open-loop control of a flow of lubricant to a reciprocating machine. The reciprocating machine can include two-stroke engines, two-stroke compressors, and combinations thereof, such as reciprocating machine 304. The method 500 is described below in connection with the lubrication bypass system 300 of FIG. 3.

In operation 502, a primary flow of a fluid lubricant is received within a lubrication line (e.g., lubrication line 312) at a primary flow rate. The lubrication line 312 is in fluid communication with a reservoir of the fluid lubricant (e.g., reservoir 306) and reciprocating machine (e.g., reciprocating machine 304). As an example, the lubrication line 312 is in fluid communication with a cylinder of the reciprocating machine 304, such as an engine cylinder (e.g., 210a) of a two-stroke engine and/or a compressor cylinder (e.g., 220a) of a two-stroke compressor.

In operation 504, at least one operating parameter of the reciprocating machine 304 is received (e.g., by the bypass valve controller 320). The bypass valve controller 320 receives the operating parameter in the form of one or more operating signals (e.g., 324s, 326s, 332s) including data representing respective operating parameters. In one aspect, an operating parameter is the current load of the reciprocating machine 304. In another aspect, operating parameters are the current load and the current speed of the reciprocating machine 304. In a further aspect, operating parameters are the current load of the reciprocating machine 304, the current speed of the reciprocating machine 304, and a temperature of an environment surrounding the reciprocating machine 304.

In operation 506, the bypass valve controller 320 determines a first valve control signal (e.g., 330s) based upon the received operating parameters. As an example, the bypass valve controller 320 determines the valve control signal 330s based upon a predetermined formula or a lookup table using the received operating parameters as inputs.

In operation 510, the valve control signal 330s is transmitted to a bypass valve (e.g., bypass valve 316) positioned within a bypass line 314 and in fluid communication with a lubrication line at a junction (e.g., junction J). The valve control signal 330s is transmitted by the bypass valve controller 320 based upon the operating parameter(s). The valve control signal 330s is operative to adjust the first bypass valve such that a portion of a primary flow of fluid lubrication (e.g., the bypass flow) is diverted from the lubrication line to the bypass line at a bypass flow rate. Concurrently, a secondary flow of the fluid lubricant remains within the lubrication line and passes from the junction to the reciprocating machine 304 at a secondary flow rate. As discussed above, the secondary flow rate can be a target secondary flow rate approximately equal to a recommended lubrication rate for the reciprocating machine 304 operating at the received operating parameter(s).

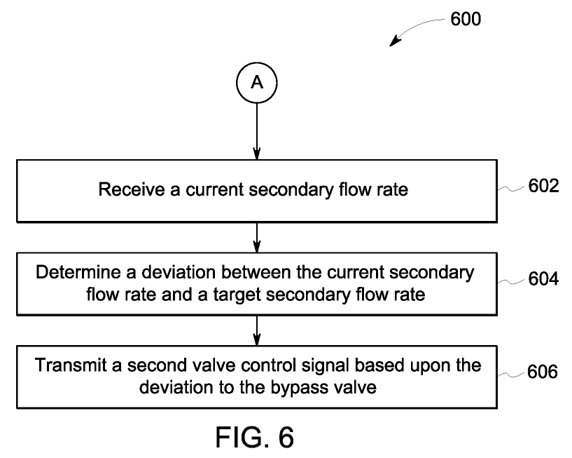

FIG. 6 is a flow diagram illustrating an exemplary embodiment of a method 600 for closed-loop control of a flow of lubricant to a reciprocating machine, such as reciprocating machine 304. The reciprocating machine 304 can include two-stroke engines, two-stroke compressors, and combinations thereof. The method 600 is described below in connection with the lubrication bypass system 400 of FIG. 4.

In an embodiment, the method 600 includes operations 502-510, as discussed above. Following operation 510, the method 600 moves to operation 602, where a current secondary flow rate is received (e.g., by the bypass valve controller 320). As an example, the current secondary flow rate can be measured by a flow meter (e.g., 402) positioned within the lubrication line 312 between the junction J and the reciprocating machine 304 (e.g., the second portion 312b of the lubrication line 312). The flow meter 402 is configured to transmit a flow rate signal (e.g., 402s) containing data representing the current secondary flow rate to the bypass valve controller 320.

In operation 604, a deviation between the current secondary flow rate and a target secondary flow rate is determined. As an example, the target secondary flow rate is determined from the operating parameter by the bypass valve controller 320, as discussed above.

In operation 606, the bypass valve controller 320 transmits a valve control signal (e.g., 404s) to the bypass valve 316 based upon the determined deviation.

Operations 602-606 can be repeated as necessary to reduce the deviation below the threshold.

In certain aspects, embodiments of the methods 500, 600 have been described with regard to FIGS. 5 and 6, respectively. However, the methods 500, 600 can include greater or fewer operations than those illustrated in FIGS. 5 and 6 and their operations can be performed in a different order than illustrated in FIGS. 5 and 6.

Embodiments of the present disclosure can be described in the following exemplary clauses, which may be combined in any fashion unless otherwise noted.

In one embodiment, a lubrication bypass system includes a lubrication line, a bypass line, a first bypass valve, and a bypass valve controller. The lubrication line is in fluid communication with a reciprocating machine and is configured to receive a primary flow of a fluid lubricant. The bypass line in fluid communication with the lubrication line at a junction and it is configured to divert a portion of the primary flow of fluid lubricant from the lubrication line to the bypass line at a bypass flow rate such that a secondary flow of fluid lubricant passes from the junction to the reciprocating machine at a secondary flow rate. The first bypass valve is positioned along the bypass line and it is configured to adjust the bypass flow rate in response to a valve control signal. The secondary flow rate can change in response to adjustment of the bypass flow rate. The bypass valve controller is communicatively coupled to the first bypass valve and it is configured to receive at least one operating signal including data representing an operating parameter of the reciprocating machine. The bypass valve controller is also configured to transmit the valve control signal based upon the received at least one operating signal.

Embodiments of the at least one operating signal can have a variety of configurations. In one aspect, the at least one operating signal includes a load signal including data representing a load of the reciprocating machine. In another aspect, the at least one operating signal further includes at least one of a speed signal including data representing a speed of the reciprocating machine and a temperature signal representing a temperature of an environment surrounding the reciprocating machine cylinder.

In another embodiment, the bypass valve controller is further configured to receive a flow rate signal including data representing the secondary flow rate, and to transmit the valve control signal based upon the received at least one operating signal and the received flow rate signal.

In another embodiment, a second bypass valve is positioned along the bypass line between the junction and the first bypass valve. The second bypass valve is configured to limit the bypass flow rate such that the secondary flow rate is greater than or equal to a predetermined minimum flow rate.

In another embodiment, the reciprocating machine includes a two-stroke engine and the lubrication line is in fluid communication with a cylinder of the two-stroke engine.

In another embodiment, the reciprocating machine includes a two-stroke compressor and the lubrication line is in fluid communication with a cylinder of the two-stroke compressor.

In one embodiment, a compression system includes a two-stroke engine, a two-stroke compressor, and a lubrication bypass system. The engine includes a reciprocating engine piston positioned within an engine cylinder. The compressor includes a reciprocating compressor piston positioned within a compressor cylinder. The compressor piston is in mechanical communication with the engine piston and it is configured to reciprocate within the compressor cylinder in response to mechanical power received from the engine piston. The lubrication bypass system includes a lubrication line, a bypass line, and a first bypass valve. The lubrication line is configured to receive a primary flow of a fluid lubricant at a primary flow rate, and it directs at least a portion of the fluid lubricant to the engine cylinder. The bypass line is in fluid communication with the lubrication line at a junction and it is configured to receive a bypass flow of the fluid lubricant from the lubrication line at a bypass flow rate. The bypass flow includes a portion of the primary flow diverted from the bypass line. The first bypass valve is positioned within the bypass line and it is configured to adjust the bypass flow rate in response to a valve control signal.

In another embodiment, the compression system includes a bypass valve controller communicatively coupled to the first bypass valve. The bypass valve controller is configured to transmit the valve control signal based upon one or more operating parameters of the engine including an engine load.

In another embodiment, the bypass valve controller is further configured to output the valve control signal based upon the one or more operating parameters of the engine cylinder and a flow rate of lubrication within the lubrication line between the junction and the engine cylinder.

In another embodiment, the one or more operating parameters further include at least one of an engine speed and a temperature of an environment surrounding the engine.

In another embodiment, a second bypass valve is positioned along the bypass line between the junction and the first bypass valve. The second bypass valve is configured to limit the bypass flow rate such that a secondary flow rate of lubrication within the lubrication line between the junction and the engine cylinder is greater than or equal to a predetermined minimum flow rate.

Methods for lubricating a reciprocating machine are also disclosed. In one embodiment, the method includes receiving, by a bypass valve controller, at least one operating signal that includes data representing operating parameters of a reciprocating machine cylinder. The method also includes determining, by the bypass valve controller, a first valve control signal based upon the received operating parameters. The method further includes transmitting the first valve control signal to a first bypass valve positioned along a bypass line in fluid communication with a lubrication line at a junction. The first valve control signal is operative to adjust the first bypass valve such that a portion of a primary flow of fluid lubricant delivered to the junction via the lubrication line is diverted from the lubrication line to the bypass line at a bypass flow rate. A secondary flow of the fluid lubricant remains within the lubrication line and passes from the junction to the reciprocating machine cylinder at a secondary flow rate.

In another embodiment, the method includes receiving, by the bypass valve controller, a flow rate signal including data representing the secondary flow rate, and transmitting, by the bypass valve controller, the valve control signal based upon the received at least one operating signal and the received flow rate signal.

Embodiments of the operating signal can have a variety of configurations. In one aspect, the at least one operating signal includes a load signal including data representing a load of the reciprocating machine. In another aspect, the at least one operating signal further includes at least one of a speed signal including data representing a speed of the reciprocating machine and a temperature signal including data representing a temperature of an environment surrounding the reciprocating machine cylinder.

In another embodiment, the method includes transmitting, by the bypass valve controller, a second valve control signal to a second bypass valve positioned along the bypass line between the junction and the first bypass valve. The second valve control signal is operative to adjust the second bypass valve such that the bypass flow rate is limited to less than or equal to a predetermined maximum bypass flow rate.

Embodiments of the reciprocating machine cylinder can have a variety of configurations. In one aspect, the reciprocating machine cylinder is an engine cylinder of a two-stroke engine. In another aspect, the reciprocating machine cylinder is a compressor cylinder of a two-stroke compressor.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To allow for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

Certain exemplary embodiments are described for an overview of the principles of the structure, function, manufacture, and use of the systems, devices, and methods disclosed herein. One or more examples of these embodiments are illustrated in the accompanying drawings. The features illustrated or described in connection with one exemplary embodiment can be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. A lubrication bypass system, comprising:
a lubrication line in fluid communication with a reciprocating machine, the lubrication line configured to receive a primary flow of a fluid lubricant;
a bypass line in fluid communication with the lubrication line at a junction and configured to divert a portion of the primary flow of fluid lubricant from the lubrication line to the bypass line at a bypass flow rate such that a secondary flow of the fluid lubricant passes from the junction to the reciprocating machine at a secondary flow rate;
a first bypass valve positioned along the bypass line and configured to adjust the bypass flow rate in response to a valve control signal, wherein the secondary flow rate changes in response to adjustment of the bypass flow rate; and
a bypass valve controller communicatively coupled to the first bypass valve and configured to receive at least one operating signal including data representing an operating parameter of the reciprocating machine, and to transmit the valve control signal based upon the received at least one operating signal.

2. The lubrication bypass system of claim 1, wherein the at least one operating signal comprises a load signal including data representing a load of the reciprocating machine.

3. The lubrication bypass system of claim 2, wherein the at least one operating signal further comprises at least one of a speed signal including data representing a speed of the reciprocating machine and a temperature signal including data representing a temperature of an environment surrounding the reciprocating machine cylinder.

4. The lubrication bypass system of claim 1, wherein the bypass valve controller is further configured to receive a flow rate signal including data representing the secondary flow rate, and transmit the valve control signal based upon the received at least one operating signal and the received flow rate signal.

5. The lubrication bypass system of claim 1, further comprising a second bypass valve positioned along the bypass line between the junction and the first bypass valve, wherein the second bypass valve is configured to limit the bypass flow rate such that the secondary flow rate is greater than or equal to a predetermined minimum flow rate.

6. The lubrication bypass system of claim 1, wherein the reciprocating machine comprises a two-stroke engine and the lubrication line is in fluid communication with a cylinder of the two-stroke engine.

7. The lubrication bypass system of claim 1, wherein the reciprocating machine comprises a two-stroke compressor and the lubrication line is in fluid communication with a cylinder of the two-stroke compressor.

8. A compression system, comprising:
a two-stroke engine including a reciprocating engine piston positioned within an engine cylinder;
a two-stroke compressor including a reciprocating compressor piston positioned within a compressor cylinder, wherein the compressor piston is in mechanical communication with the engine piston and is configured to reciprocate within the compressor cylinder in response to mechanical power received from the engine piston; and
a lubrication bypass system, including,
a lubrication line configured to receive a primary flow of a fluid lubricant at a primary flow rate, and to direct at least a portion of the fluid lubricant to the engine cylinder,
a bypass line in fluid communication with the lubrication line at a junction and configured to receive a bypass flow of the fluid lubricant from the lubrication line at a bypass flow rate, the bypass flow including a portion of the primary flow diverted from the bypass line, and
a first bypass valve positioned within the bypass line and configured to adjust the bypass flow rate in response to a valve control signal.

9. The compression system of claim 8, further comprising a bypass valve controller communicatively coupled to the first bypass valve and configured to transmit the valve control signal based upon one or more operating parameters of the engine including an engine load.

10. The compression system of claim 9, wherein the bypass valve controller is further configured to output the valve control signal based upon the one or more operating parameters of the engine cylinder and a flow rate of lubrication within the lubrication line between the junction and the engine cylinder.

11. The compression system of claim 9, wherein the one or more operating parameters further comprise at least one of an engine speed and a temperature of an environment surrounding the engine.

12. The compression system of claim 8, further comprising a second bypass valve positioned along the bypass line between the junction and the first bypass valve, wherein the second bypass valve is configured to limit the bypass flow rate such that a secondary flow rate of lubrication within the lubrication line between the junction and the engine cylinder is greater than or equal to a predetermined minimum flow rate.

13. A method of lubricating a reciprocating machine, comprising:
receiving, by a bypass valve controller, at least one operating signal that includes data representing operating parameters of a reciprocating machine cylinder;
determining, by the bypass valve controller, a first valve control signal based upon the received operating parameters; and
transmitting the first valve control signal to a first bypass valve positioned along a bypass line in fluid communication with a lubrication line at a junction;
wherein the first valve control signal is operative to adjust the first bypass valve such that a portion of a primary flow of fluid lubricant delivered to the junction via the lubrication line is diverted from the lubrication line to the bypass line at a bypass flow rate and a secondary flow of the fluid lubricant remains within the lubrication line and passes from the junction to the reciprocating machine cylinder at a secondary flow rate.

14. The method of claim 13, further comprising:
receiving, by the bypass valve controller, a flow rate signal including data representing the secondary flow rate; and
determining, by the bypass valve controller, the first valve control signal based upon the at least one operating signal and the received flow rate signal.

15. The method of claim 13, wherein the at least one operating signal comprises a load signal including data representing a load of the reciprocating machine.

16. The method of claim 15, wherein the at least one operating signal further comprises at least one of a speed signal including data representing a speed of the reciprocating machine and a temperature signal including data representing a temperature of an environment surrounding the reciprocating machine cylinder.

17. The method of claim 13, further comprising transmitting, by the bypass valve controller, a second valve control signal to a second bypass valve positioned along the bypass line between the junction and the first bypass valve.

18. The method of claim 17, wherein the second valve control signal is operative to adjust the second bypass valve such that the bypass flow rate is limited to less than or equal to a predetermined maximum bypass flow rate.

19. The method of claim 13, wherein the reciprocating machine cylinder is an engine cylinder of a two-stroke engine.

20. The method of claim 13, wherein the reciprocating machine cylinder is a compressor cylinder of a two-stroke compressor.
